(19) United States
(12) Patent Application Publication
(10) Pub. No.: US 2023/0295526 A1
(43) Pub. Date: Sep. 21, 2023

(54) PROCESS AND PLANT FOR PRODUCING GASOLINE FROM A RENEWABLE FEED

(71) Applicant: Topsoe A/S, Kgs. Lyngby (DK)

(72) Inventors: Erik BEK-PEDERSEN, Naerum (DK); Søren Selde ENEVOLDSEN, Fredensborg (DK)

(73) Assignee: Topsoe A/S, Kgs. Lyngby (DK)

(21) Appl. No.: 18/006,545

(22) PCT Filed: Aug. 12, 2021
(86) PCT No.: PCT/EP2021/072527

§ 371 Date: Jan. 23, 2023

(30) Foreign Application Priority Data
Aug. 13, 2020 (EP) 20190951.2

(51) Int. Cl. C10G 69/08; C01B 3/38; C10G 3/00; C10G 35/06

(52) U.S. Cl. CPC C10G 69/08; C01B 3/38; C10G 3/52; C10G 35/065; C01B 2203/0233; C01B 2203/0283; C01B 2203/043; C01B 2203/065; C01B 2203/1258; C10G 2400/02; C10G 2300/305; C10G 2300/1003; C10G 2300/42; C10G 2300/4081; C10G 2300/1014; C10G 2300/1018; C01B 2203/0415

(57) ABSTRACT

The present invention relates to a process and plant for producing hydrocarbon product boiling in the gasoline boiling range from a feedstock originating from a renewable source, the process and plant comprising a hydroprocessing stage which includes hydrodoxygenation for producing renewable diesel and renewable naphtha, and subsequent aromatization of the renewable naphtha thereby also producing a lighthydrocarbon gas stream, such as liquid petroleum gas (LPG), from which a hydrogen stream is produced.

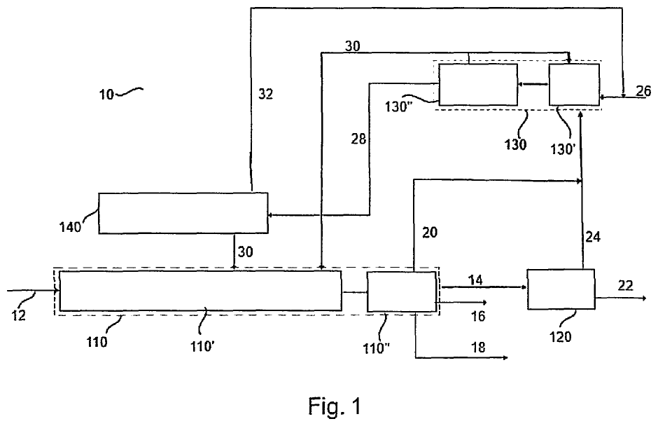

### FIELD OF THE INVENTION

The present invention relates to a process and plant for producing a high-quality gasoline from a feedstock originating from a renewable source, the process and plant comprising one or more hydroprocessing stages which includes hydrodeoxygenation for producing renewable diesel and renewable naphtha, and subsequent aromatization of the renewable naphtha, thereby also producing a light hydrocarbon gas, such as a liquid petroleum gas (LPG), from which a hydrogen stream is produced and which may be used in the process.

### BACKGROUND

The quality of gasoline (C5+ hydrocarbons) is highly dependent on the resistance to engine knocking due to compression ignition of the fuel in engines running on the gasoline. This quality is measured by the so-called octane number, originating from iso-octane being considered the ideal gasoline hydrocarbon. Thus, a pure iso-octane defines the gasoline as having the octane number 100, while a pure n-heptane defines the octane number 0. It would be desirable to produce a gasoline having a research octane number (RON) of at least 85, such as 90 or higher.

In practice, gasoline is a complex hydrocarbon mixture and e.g. aromatics contribute to higher knock-resistance, while saturated alkanes, especially when having a linear structure, have a higher propensity to knocking. Therefore, naphtha hydrocarbon mixtures are less valuable if the aromatic content is very low.

Naphtha having insufficient octane number may be upgraded by catalytic reforming process, which typically involves alkylation of aromatics to increase the octane number.

Normally also, in petrochemical applications paraffinic naphtha is used as feedstock for the production of olefins such as ethylene and propylene as well as aromatics, mainly benzene and toluene. The olefins are then used for producing plastics, namely polyethylene and polypropylene.

In particular, paraffinic naphtha from renewable sources, i.e. naphtha produced from the hydroprocessing of renewable feedstocks such as vegetable oils, has been considered as a waste product since the volume was small and the octane number too low for use as a blending component in gasoline.

Applicant's U.S. Pat. No. 9,752,080 discloses the use of LPG from a downstream Fischer-Tropsch (FT) process as feed to a steam reforming process for producing synthesis gas required in the FT-process.

WO 2015/075315 A1 discloses the use of LPG or naphtha in a hydrogen producing plant which is integrated in a process for producing hydrocarbons from a renewable feedstock.

U.S. Pat. No. 3,871,993 describes a process for converting virgin naphtha to a high-octane liquid gasoline product and LPG without hydrogen consumption by increasing the aromatics content of the naphtha via the use of zeolite such as ZSM-5 which may be modified with metals.

US 2012/151828 A1 discloses a process for making hydrocarbon products from renewable material. In a product recovery zone, gasoline is separated as one of the fractions and a lighter fraction which is converted to hydrogen for use in the process. In the upstream hydroprocessing, deoxygenation of oxygenated cyclic compounds in the feed is said to yield aromatics. Thus, there is no further generation of aromatics in a dedicated aromatization stage.

Applicant's co-pending European patent application EP 20162995.3 describes the production of renewable hydrocarbon products such as renewable naphtha in a process including production of hydrogen in a hydrogen producing unit which may use such renewable naphtha as part of the hydrocarbon feedstock.

The prior art is silent about a process or plant for converting a feedstock originating from a renewable source into a hydrocarbon product boiling in the gasoline boiling range by conducting hydrodeoxygenation and then a dedicated aromatization, and at the same time producing a light hydrocarbon gas such as LPG for use in the production of hydrogen which may be used in the process or plant.

### SUMMARY OF THE INVENTION

In a first aspect of the invention there is provided a process for producing a hydrocarbon product boiling in the gasoline boiling range, said process comprising the steps of:
i) converting a feedstock originating from a renewable source by one or more hydroprocessing stages into a hydrocarbon product boiling at above 30° C., including a renewable naphtha stream; wherein the one or more hydroprocessing stages comprises: hydrodeoxygenation (HDO), optionally hydrodewaxing (HDW) and optionally hydrocracking (HCR);
ii) upgrading said renewable naphtha stream by passing it through an aromatization stage comprising contacting the renewable naphtha stream with a catalyst, preferably a catalyst supported on an aluminosilicate zeolite, thereby producing said hydrocarbon product boiling in the gasoline boiling range and a separate light hydrocarbon gas stream, such as a liquid petroleum gas (LPG) stream;
iii) passing at least a portion of said light hydrocarbon gas stream to a hydrogen producing unit for producing a hydrogen stream; and
wherein said hydrocarbon product boiling in the gasoline boiling range has at least 20 wt % aromatics in C5+ and an octane number (RON) of at least 85.

In an embodiment according to the first aspect of the invention, the hydrocarbon product boiling at above 30° C. comprises said renewable naphtha, renewable diesel and lube base stock (base oil for lubes).

It would be understood that the terms “stage” and “step” may be used interchangeably.

As used herein, the term “hydrocarbon product boiling in the gasoline boiling range” means boiling in the range 30-210° C.

As used herein, “renewable naphtha” or “naphtha” means a hydrocarbon product boiling in the range 30-160° C.

As used herein, “renewable diesel” or “diesel” means a hydrocarbon product boiling in the range 120-360° C., for instance 160-360° C.

As used herein, “lube base stock” means a hydrocarbon product boiling at above 390° C.

As used herein, boiling in a given range, shall be understood as a hydrocarbon mixture of which at least 80 wt % boils in the stated range.

As used herein, “light hydrocarbon gas” means a gas mixture comprising C1-C4 gases, in particular methane, ethane, propane, butane; the light hydrocarbon gas may also comprise i-C3, i-C4 and unsaturated C3-C4 olefins. A particular light hydrocarbon gas is LPG as defined below.

As used herein, “LPG” means liquid/liquified petroleum gas, which is a gas mixture mainly comprising propane and butane, i.e. C3-C4; LPG may also comprise i-C3, i-C4 and unsaturated C3-C4 such as C4-olefins.

In an embodiment according to the first aspect of the invention, said hydrocarbon product boiling in the gasoline boiling range has at least 20 wt % aromatics in C5+, such as 20-50 wt % aromatics in C5+, and an octane number (Research Octane Number, RON) of at least 85, such as 90 or 95. As used herein, the term “high quality gasoline” is a hydrocarbon product in accordance with these specifications.

Preferably, RON is measured according to ASTM D-2699.

By treating a renewable feedstock, the renewable naphtha stream obtained as intermediate product is highly paraffinic. For instance, the renewable naphtha streams contains, preferably as measured by ASTM D-6729: at least 80 wt % or more n+i paraffins, such as 90 wt % or more n+i paraffins, for instance 95 wt % n+i paraffins, for instance at least 60 wt % n-paraffins and at least 30 or 35 wt % i-paraffins; preferably less than 5 wt % aromatics, for instance less than 2 wt % aromatics; preferably less than 5 wt % naphthenes such as less than 3 wt % naphthenes; and preferably less than 1 wt % olefins, for instance less than 0.5 wt % olefins or substantially free of olefins. The subsequent aromatization stage of the renewable naphtha stream, instead of simply using it directly as source of hydrogen in a hydrogen producing unit or using it directly as raw material in the production of ethylene and propylene, as explained in connection with the above recital of the prior art, results in a large amount of aromatics thereby increasing the octane number (RON) to at least 85, particularly 90 or higher, from as low as 50-60 in the renewable naphtha, while at the same time, a significant amount of light hydrocarbon gas, particularly LPG, is also produced e.g. 30-50 wt % LPG. The gasoline yield (C5+ yield) can also be obtained at desired levels e.g. 40-60 wt %.

The need for hydrogen in the process would typically be satisfied by external sources. In addition, as mentioned above, so far paraffinic naphtha from renewable sources i.e.

renewable naphtha, has been considered a waste product, yet by its aromatization this low value renewable naphtha is segregated into low hydrogen high-octane aromatic naphtha (high quality gasoline) and LPG with increased hydrogen density i.e. H:C-ratio. The LPG is then used for hydrogen production, thereby enabling the production of hydrogen of renewable origin that may be of value in the carbon balance of the hydrotreatment process or have a premium value in the market. A high energy efficiency in the process and plant is thereby obtained. Diesel produced in the process, i.e. renewable diesel, and which normally is the desired hydrocarbon product, may also be used as part of the hydrocarbon product pool.

Hence, by the invention a simple and elegant solution to the creation of valuable products on the basis of a renewable feedstock is achieved, by enabling among other things a significant improvement, i.e. more than expected increase of the octane number (RON) of the renewable naphtha. Hence, it is possible to increase the aromatics content from less than e.g. 2 wt % in the renewable naphtha to 20 wt % or more, such as 20-50 wt %, 25-45 wt %, or 35-45 wt % in C5+ in the high-quality gasoline. The octane number (RON) of the gasoline, having at least 20-45 wt % aromatics, is 85 or higher, such as 90 or 95. The higher the aromatics content of the gasoline, the lower the C5+ yield, yet by the invention it is possible to strike a balance by which the octane number increases significantly without reducing too much the C5+ yield. At the same time, a significant amount of LPG is formed as an additional valuable product due to the dehydrogenation that happens when aromatics are formed, and which is then converted to hydrogen in a steam reforming process in the hydrogen producing unit. Hence it is also possible to produce hydrogen of renewable origin that may have a premium value in the market.

Since the feedstock is renewable, the resulting products, namely the gasoline and diesel represent products are obtained with a significant reduction in greenhouse gas emissions.

In addition, the invention enables a simpler approach than e.g. catalytic reforming of the renewable naphtha, since the aromatization stage can be conducted at milder conditions, with less expensive catalyst and less expensive process equipment. More specifically, there is no need for noble metals or rare earth metals on the catalyst, there is no chlorine, the catalytic reactor can be operated as a fixed-bed reactor operation and thus represents a much simpler solution than conventional catalytic reformers.

In an embodiment according to the first aspect of the invention, the process further comprises:
iv) passing at least a portion of the hydrogen stream to any of the hydroprocessing stages of step i) and/or the aromatization stage of step ii).

Thus, not only the produced hydrogen stream may be used as a hydrogen product of renewable origin for end-users, but also as make-up hydrogen to provide hydrogen during the production of the high-quality gasoline, thereby improving the energy efficiency of the overall process and plant. As used herein, the term “overall process and plant” means the process and plant used to convert the feedstock origination from a renewable source to the hydrocarbon product boiling in the gasoline boiling range in accordance with above steps i)-iv). It would be understood that this encompasses also any of the below embodiments.

The one or more hydroprocessing stages in step i) comprises: hydrodeoxygenation (HDO) e.g. in a first catalytic hydrotreating; optionally hydrodewaxing (HDVV) e.g. in a second catalytic hydrotreating; and optionally hydrocracking (HCR) e.g. in an additional catalytic hydrotreating such as a third catalytic hydrotreating. HDO, HDW and HCR are defined farther below.

The effect of using HDO in the one or more hydroprocessing stages followed by aromatization of the renewable naphtha for production of high quality gasoline is highly unexpected. Producing gasoline conveys namely a yield loss compared to producing diesel which normally would be the actual desired hydrocarbon product due to diesel, being a hydrocarbon product boiling in the range 120-360° C., closely matching in boiling point with the product of HDO. Given that the feedstock used in the process originates from a renewable source, such feed would normally contain triglycerides which would result in mainly C16-C18 compounds from the HDO, thus closely matching diesel (C10-C20). While diesel may still be produced, the purposeful production of high-quality gasoline in accordance with the present invention in spite of the attendant yield loss compared to producing diesel, is highly counter-intuitive.

The material catalytically active in HDO (as used herein, interchangeable with the term hydrotreating, HDT), typically comprises an active metal (sulfided base metals such as nickel, cobalt, tungsten and/or molybdenum, but possibly also elemental noble metals such as platinum and/or palladium) and a refractory support (such as alumina, silica or titania, or combinations thereof).

HDT conditions involve a temperature in the interval 250-400° C., a pressure in the interval 30-150 bar, and a liquid hourly space velocity (LHSV) in the interval 0.1-2, optionally together with intermediate cooling by quenching with cold hydrogen, feed or product.

The material catalytically active in HDW typically comprises an active metal (either elemental noble metals such as platinum and/or palladium or sulfided base metals such as nickel, cobalt, tungsten and/or molybdenum), an acidic support (typically a molecular sieve showing high shape selectivity, and having a topology such as MOR, FER, MRE, MVWV, AEL, TON and MTT) and a refractory support (such as alumina, silica or titania, or combinations thereof).

Isomerization conditions involve a temperature in the interval 250-400° C., a pressure in the interval 20-100 bar, and a liquid hourly space velocity (LHSV) in the interval 0.5-8.

The material catalytically active in HCR is of similar nature to the material catalytically active in isomerization, and it typically comprises an active metal (either elemental noble metals such as platinum and/or palladium or sulfided base metals such as nickel, cobalt, tungsten and/or molybdenum), an acidic support (typically a molecular sieve showing high cracking activity, and having a topology such as MFI, BEA and FAU) and a refractory support (such as alumina, silica or titania, or combinations thereof). The difference to material catalytically active isomerization is typically the nature of the acidic support, which may be of a different structure (even amorphous silica-alumina) or have a different acidity e.g. due to silica:alumina ratio.

HCR conditions involve a temperature in the interval 250-400° C., a pressure in the interval 30-150 bar, and a liquid hourly space velocity (LHSV) in the interval 0.5-8, optionally together with intermediate cooling by quenching with cold hydrogen, feed or product.

In an embodiment according to the first aspect of the invention, in step (ii) the catalyst is incorporated, e.g. supported, in an aluminosilicate zeolite, such as a catalyst incorporated in a zeolite having a MFI structure, in particular ZSM-5, preferably Zn-ZSM-5, ZnP-ZSM-5, Ni-ZSM-5, or combinations thereof; the temperature is in the range 300-500° C., such as 300-460° C. or 300-420° C., the pressure is 1-30 bar such as 2-30 bar or 10-30 bar, and optionally there is addition of hydrogen, i.e. optionally, the aromatization is conducted in the presence of hydrogen. In a particular embodiment, the liquid hourly space velocity (LHSV) is in the interval 1-3, for instance 1.5-2.

As used herein, the term “MFI structure” means a structure as assigned and maintained by the International Zeolite Association Structure Commission in the Atlas of Zeolite Framework Types, which is at http://www.iza-structure.org/databases/ or for instance also as defined in “Atlas of Zeolite Framework Types”, by Ch. Baerlocher, L. B. McCusker and D. H. Olson, Sixth Revised Edition 2007.

As used herein, “Zn-ZSM-5” means Zn incorporated in the zeolite ZSM-5, and includes Zn supported on ZSM-5. The same interpretation applies when using ZnP, or Ni.

In an embodiment according to the first aspect of the invention, step ii) comprises providing after said aromatization stage an isomerization stage, said aromatization stage producing a raw upgraded renewable naphtha stream which is passed through said isomerization stage for thereby forming said hydrocarbon product boiling in the gasoline boiling range. The above recited isomerization conditions may be used in this isomerization.

In a particular embodiment, the process further comprises using a portion of a light hydrocarbon gas stream, e.g. a LPG stream, in particular the light hydrocarbon gas stream obtained in step ii), or a portion of the renewable naphtha stream as heat exchanging medium for quenching said raw upgraded renewable naphtha stream.

Thereby a staged feeding of the feed to the isomerization stage is achieved to improve isomerization and thereby also an increase in aromatization. For instance, by installing an isomerization reactor downstream and aromatization reactor. Isomerization is favored by a lower temperature than the aromatization. Further, make-up hydrogen, for instance hydrogen produced in the hydrogen producing unit may be added in the isomerization, i.e. hydroisomerization (HDI). The product of the aromatization stage gains thereby also an even higher octane number than it otherwise would be possible, i.e. without the isomerization.

In an embodiment according to the first aspect of the invention, the hydrogen producing unit comprises feeding a hydrocarbon feedstock such as natural gas. Hence, the hydrogen producing unit, apart from using the light hydrocarbon gas, particularly LPG, as feedstock, may also use another hydrocarbon feedstock, such as natural gas.

Optionally, in step i) a separate LPG stream is also formed which is also used as hydrocarbon feedstock in the hydrogen producing unit. Preferably the renewable naphtha stream and LPG stream in step i) are withdrawn from the same unit, such as a separation unit e.g. a distillation unit.

In an embodiment according to the first aspect of the invention, the hydrogen producing unit comprises subjecting said light hycrocarbon gas stream and said hydrocarbon feedstock to: cleaning in a cleaning unit, said cleaning unit preferably being a sulfur-chlorine-metal absorption or catalytic unit; optionally pre-reforming in a pre-reforming unit; catalytic steam methane reforming in a steam reforming unit; water gas shift conversion in a water gas shift unit; optionally carbon dioxide removal in a CO₂-separator unit; and optionally hydrogen purification in a hydrogen purification unit. It would be understood that the provision of said another i.e. separate hydrocarbon feedstock, such as natural gas, is optional.

In a particular embodiment, the hydrogen purification unit is a Pressure Swing Adsorption unit (PSA unit), said PSA unit producing an off-gas stream which is used as fuel in the steam reforming unit of the hydrogen producing unit, and/or in fired heaters in any of the hydroprocessing stages of step i), and or the aromatization stage of step ii), and/or for steam production. This enables further reduction of hydrocarbon consumption, thereby improving energy consumption figures, i.e. higher energy efficiency, as PSA off-gas which otherwise will need to be burned off (flared), is expediently used in the process.

In an embodiment according to the first aspect of the invention, the steam reforming unit is: a convection reformer, preferably comprising one or more bayonet reforming tubes such as an HTCR reformer i.e. Topsese bayonet reformer, where the heat for reforming is transferred by convection along with radiation; a tubular reformer i.e. conventional steam methane reformer (SMR), where the heat for reforming is transferred chiefly by radiation in a radiant furnace; autothermal reformer (ATR), where partial oxidation of the hydrocarbon feed with oxygen and steam followed by catalytic reforming; electrically heated steam methane reformer (e-SMR), where electrical resistance is used for generating the heat for catalytic reforming; or combinations thereof. In particular, when using e-SMR, electricity from green resources may be utilized, such as from electricity produced by wind power, hydropower, and solar sources, thereby further minimizing the carbon dioxide footprint.

For more information on these reformers, details are herein provided by direct reference to Applicant's patents and/or literature. For instance, for tubular and autothermal reforming an overview is presented in “Tubular reforming and autothermal reforming of natural gas—an overview of available processes”, lb Dybkjr, Fuel Processing Technology 42 (1995) 85-107; and EP 0535505 for a description of HTCR. For a description of ATR and/or SMR for large scale hydrogen production, see e.g. the article “Large-scale Hydrogen Production”, Jens R. Rostrup-Nielsen and Thomas Rostrup-Nielsen”, CATTECH 6, 150-159 (2002).

For a description of e-SMR which is a more recent technology, reference is given to particularly WO 2019/228797 A1.

In an embodiment, the catalyst in the steam reforming unit is a reforming catalyst, e.g.

a nickel-based catalyst. In an embodiment, the catalyst in the water gas shift reaction is any catalyst active for water gas shift reactions. The said two catalysts can be identical or different. Examples of reforming catalysts are Ni/MgAl2O4, Ni/Al2O3, Ni/CaAl2O4, Ru/MgAl2O4, Rh/MgAl2O4, Ir/MgAl2O4, Mo2C, Wo2C, CeO2, Ni/ZrO2, Ni/MgAl2O3, Ni/CaAl2O3, Ru/MgAl2O3, or Rh/MgAl2O3, a noble metal on an Al2O3 carrier, but other catalysts suitable for reforming are also conceivable. The catalytically active material may be Ni, Ru, Rh, Ir, or a combination thereof, while the ceramic coating may be Al2O3, ZrO2, MgAl2O3, CaAl2O3, or a combination therefore and potentially mixed with oxides of Y, Ti, La, or Ce. The maximum temperature of the reactor may be between 850-1300° C. The pressure of the feed gas may be 15-180 bar, preferably about 25 bar. Steam reforming catalyst is also denoted steam methane reforming catalyst or methane reforming catalyst.

In an embodiment according to the first aspect of the invention, prior to passing the hydrogen stream to any of the hydroprocessing stages of step i) and/or the aromatization stage of step ii), the make-up hydrogen stream passes through a compressor section comprising a make-up compressor optionally also a recycle compressor, the make-up compressor also producing a hydrogen recycle stream which is added to the hydrogen producing unit, and/or to the cleaning unit of the hydrogen producing unit.

This enables integration of the hydrogen producing plant and the plant for producing the renewable hydrocarbon product boiling in the gasoline boiling range, since there is no need for a separate or dedicated compressor for recycling hydrogen within the hydrogen producing unit for e.g. hydrogenation of sulfur in the cleaning unit.

In an embodiment according to the first aspect, in step i) the renewable source is a raw material of renewable origin, such as originating from plants, algae, animals, fish, vegetable oil refining, domestic waste, tires, waste rich in plastic, industrial organic waste like tall oil or black liquor, or a feedstock derived from one or more oxygenates taken from the group consisting of triglycerides, fatty acids, resin acids, ketones, aldehydes or alcohols where said oxygenates originate from one or more of a biological source, a gasification process, a pyrolysis process, a hydrothermal liquefaction process or any other liquefication process, Fischer-Tropsch synthesis, or methanol based synthesis. The oxygenates may also originate from a further synthesis process. Some of these feedstocks may contain aromatics; especially products from pyrolysis processes or waste products from e.g. frying oil. Any combinations of the above feedstocks are also envisaged.

In an embodiment according to the first aspect, step i) also comprises adding a feedstock originating from a fossil fuel source, such as diesel, kerosene, naphtha, and vacuum gas oil (VGO), and/or recycling a hydrocarbon product. This additional feedstock acts as a hydrocarbon diluent, thereby enabling the absorption of heat from the exothermal reactions in the catalytic hydrotreating unit(s) of the hydroprocessing stage.

In a second aspect, the invention is a plant, i.e. process plant, for producing a hydrocarbon product boiling in the gasoline boiling range, comprising:
a hydroprocessing section arranged to receive a feedstock originating from a renewable source and optionally also for receiving a compressed hydrogen stream, for producing a renewable naphtha product; said hydroprocessing section comprising a hydrodeoxygenation (HDO) unit, optionally a hydrodewaxing (HDVV) unit and optionally a hydrocracking (HCR) unit;
an aromatization section comprising a reactor containing a catalyst, preferably a catalyst comprising an alumininosilicate zeolite, and arranged to receive said renewable naphtha product for producing said hydrocarbon product boiling in the gasoline boiling range and a light hydrocarbon gas stream, such as a liquid petroleum gas (LPG) stream;
a hydrogen producing unit (HPU) arranged to receive said light hydrocarbon gas stream and optionally arranged to also receive a separate hydrocarbon feedstock stream such as natural gas stream for producing a hydrogen stream.

Any of the above embodiments of the first aspect of the invention and associated benefits may be used together with the second aspect of the invention.

### BRIEF DESCRIPTION OF THE DRAWINGS

The sole FIGURE shows a schematic flow diagram of the overall process/plant according to an embodiment of the invention.

### DETAILED DESCRIPTION

With reference to the FIGURE, a block flow diagram of the overall process/plant 10 is shown, where a feedstock from a renewable source 12 is fed to the hydroprocessing stage 110. This stage or section comprises a feed section and reactor section 110′ including HDO, optional HDW and HCR units, and a separation stage 110″ which produces hydrocarbon products in the form of renewable naphtha 14 as an intermediate product, renewable diesel 16 and a bottom product such as lube base stock (base oil for lubes) 18. In addition, an LPG stream 20 is also produced. In view of diesel normally matching in boiling point with the intermediate product from HDO, the normal choice would be to focus on producing the renewable diesel 16. However, by the present invention, the focus is the production of gasoline, in spite of yield loss, from the renewable naphtha instead.

The renewable naphtha 14, instead of being used as hydrocarbon source for hydrogen production, is then passed to aromatization stage 120 comprising a reactor containing a catalyst comprising an aluminosilicate zeolite, thereby increasing the aromatic content of the naphtha and significantly increasing the octane number, by forming a high-quality gasoline product 22 having an octane number (RON) of 85 or higher, such as 90 or higher. The aromatization stage 120 may also include an isomerization stage (not shown). From this aromatization stage 120 a light hydrocarbon gas stream, in particular LPG stream 24, is produced, which is then used as feed for the hydrogen producing unit 130, together with an optional separate hydrocarbon feedstock stream 26 such as natural gas used as make-up gas for the steam reforming in the hydrogen producing unit 130. LPG stream 20 from the separation section 110″ may also be added, as shown in the FIGURE. The LPG stream(s) may be mixed and then co-fed with the natural gas stream 26 to the hydrogen producing unit 130.

The hydrogen producing unit 130 comprises a first section 130′ which includes a cleaning unit such as sulfur-chlorine-metal absorption or catalytic unit, one or more pre-reformer units, steam reformer preferably a convection reformer (e.g. HTCR), and water gas shifting unit(s), as it is well known in the art of hydrogen production; none of these units are shown here. A hydrogen purification unit, such as PSA unit 130″, is optionally provided to further enrich the gas and produce a hydrogen stream 28. Off-gas 30 from the PSA unit (PSA off-gas) is used as fuel in the hydrogen producing unit, and in particular as fuel for a HTCR unit, more particularly the burner of the HTCR unit, as well as in the hydroprocessing stage 110.

The hydrogen stream 28 may be exported as hydrogen product of renewable origin and/or may be used as make-up hydrogen in the process. Thus, when used in the process, the hydrogen stream 28 passes to a compressor section 140 which includes make-up gas compressor an optionally also a recycle compressor, not shown. An optional hydrogen-rich stream (not shown) which may have been produced in the hydroprocessing stage 110 and make-up hydrogen stream 28 are then compressed by respectively the recycle compressor and the make-up compressor and used for adding hydrogen as make-up hydrogen stream 30 into the hydroprocessing stage 110, and optionally also (not shown) to the aromatization stage 120. From the make-up compressor, a hydrogen stream 32 is recycled to hydrogen production unit 130.

1. A process for producing a hydrocarbon product boiling in the gasoline boiling range, said process comprising the steps of:
i) converting a feedstock originating from a renewable source by one or more hydroprocessing stages into a hydrocarbon product boiling at above 30° C., including a renewable naphtha stream; wherein the one or more hydroprocessing stages comprises: hydrodeoxygenation (HDO);
ii) upgrading upgrading said renewable naphtha stream by passing it through an aromatization stage comprising contacting the renewable naphtha stream with a catalyst, thereby producing said hydrocarbon product boiling in the gasoline boiling range and a separate light hydrocarbon gas stream, such as liquid petroleum gas (LPG) stream;
iii) passing at least a portion of said light hydrocarbon gas stream to a hydrogen producing unit for producing a hydrogen stream; and
wherein said hydrocarbon product boiling in the gasoline boiling range has at least 20 wt % aromatics in C5+ and an octane number (RON) of at least 85.

2. Process according to claim 1 further comprising:
iv) passing at least a portion of the hydrogen stream to any of the hydroprocessing stages of step i) and/or the aromatization stage of step ii).

3. A process according to claim 1, wherein in step (ii) the catalyst is incorporated in an aluminosilicate zeolite, the temperature is in the range 300-500° C., and the pressure is 1-30 bar.

4. A process according to claim 1, wherein step ii) comprises providing after said aromatization stage an isomerization stage, said aromatization stage producing a raw upgraded renewable naphtha stream which is passed through said isomerization stage for thereby forming said hydrocarbon product boiling in the gasoline boiling range.

5. A process according to claim 4, further comprising using a portion of a light hydrocarbon gas stream or a portion of the renewable naphtha stream as heat exchanging medium for quenching said raw upgraded renewable naphtha stream.

6. Process according to claim 1, wherein the hydrogen producing unit comprises feeding a hydrocarbon feedstock such as natural gas.

7. Process according to claim 1, wherein the hydrogen producing unit comprises subjecting said light hydrocarbon gas stream and said hydrocarbon feedstock to: cleaning in a cleaning unit.

8. Process according to claim 7, wherein the hydrogen purification unit is a Pressure Swing Adsorption unit (PSA unit), said PSA unit producing an off-gas stream which is used as fuel in the steam reforming unit of the hydrogen producing unit, and/or in fired heaters in any of the hydroprocessing stages of step i), and or the aromatization stage of step ii), and/or for steam production.

9. Process according to claim 1, wherein the steam reforming unit is: a convection reformer, a tubular reformer, autothermal reformer (ATR), electrically heated steam methane reformer (e-SMR), or combinations thereof.

10. Process according to claim 1, wherein prior to passing the hydrogen stream to any of the hydroprocessing stages of step i) and/or the aromatization stage of step ii), the hydrogen stream passes through a compressor section comprising a make-up compressor, the make-up compressor also producing a hydrogen recycle stream which is added to the hydrogen producing unit, and/or to the cleaning unit of the hydrogen producing unit.

11. Process according to claim 1, wherein in step i) the renewable source is a raw material of renewable origin, such as originating from plants, algae, animals, fish, vegetable oil refining, domestic waste, tires, waste rich in plastic, industrial organic waste like tall oil or black liquor, or a feedstock derived from one or more oxygenates taken from the group consisting of triglycerides, fatty acids, resin acids, ketones, aldehydes or alcohols where said oxygenates originate from one or more of a biological source, a gasification process, a pyrolysis process, hydrothermal liquefaction or any other liquefaction process, Fischer-Tropsch synthesis, or methanol based synthesis.

12. Process according to claim 1, wherein step i) also comprises adding a feedstock originating from a fossil fuel source, such as diesel, kerosene, naphtha, and vacuum gas oil (VGO), and/or recycling a hydrocarbon product.

13. A plant for producing a hydrocarbon product boiling in the gasoline boiling range, comprising:
a hydroprocessing section arranged to receive a feedstock originating from a renewable source and optionally also for receiving a compressed hydrogen stream, for producing a renewable naphtha product; said hydroprocessing section comprising a hydrodeoxygenation (HDO) unit, optionally a hydrodewaxing (HDVV) unit and optionally a hydrocracking (HCR) unit;
an aromatization section comprising a reactor containing a catalyst, preferably a catalyst comprising an alumininosilicate zeolite, and arranged to receive said renewable naphtha product for producing said hydrocarbon product boiling in the gasoline boiling range and a light hydrocarbon gas stream, such as a liquid petroleum gas (LPG) stream;
a hydrogen producing unit (HPU) arranged to receive said light hydrocarbon gas stream and optionally arranged to also receive a separate hydrocarbon feedstock stream such as natural gas stream for producing a hydrogen stream.

14. The process of claim 1, wherein the one or more hydroprocessing stages comprises: hydrodewaxing (HDVV) and/or hydrocracking (HCR).

15. The process of claim 1, wherein the catalyst comprises an aluminosilicate zeolite.

16. The process of claim 3, wherein step (ii) comprises addition of hydrogen.

17. The process of claim 3, wherein aluminosilicate zeolite is a zeolite having an MFI-structure selected from the group consisting of Zn-ZSM-5, ZnP-ZSM-5, Ni-ZSM-5, and combinations thereof.

18. The process of claim 7, wherein said cleaning unit is a sulfur-chlorine-metal absorption or catalytic unit.

19. The process of claim 7, wherein the hydrogen producing unit comprises subjecting said light hydrocarbon gas stream and said hydrocarbon feedstock to: pre-reforming in a pre-reforming unit; catalytic steam methane reforming in a steam reforming unit; and/or water gas shift conversion in a water gas shift unit; and/or carbon dioxide removal in a CO2-separator unit; and/or hydrogen purification in a hydrogen purification unit.

20. The process of claim 10, wherein the hydrogen stream passes through the compressor section further comprising a recycle compressor.
